(19) United States
(12) Patent Application Publication
(10) Pub. No.: US 2026/0258523 A1
(43) Pub. Date: Sep. 3, 2026

(54) BATTERY RECYCLING MATERIALS

(71) Applicant: UCHICAGO ARGONNE, LLC, Chicago, IL (US)

(72) Inventors: Zhengcheng ZHANG, Naperville, IL (US); Ting-Wei HSU, Bolingbrook, IL (US); John T. VAUGHEY, Elmhurst, IL (US)

(73) Assignee: UCHICAGO ARGONNE, LLC, Chicago, IL (US)

(21) Appl. No.: 19/431,041

(22) Filed: Dec. 23, 2025

Related U.S. Application Data
(60) Provisional application No. 63/765,297, filed on Feb. 28, 2025.

(51) Int. Cl. C22B 3/36; C08F 8/44; C08J 3/28; H01M 10/54

(52) U.S. Cl. CPC C22B 3/362; C08F 8/44; C08J 3/28; H01M 10/54; C08J 2333/14

(57) ABSTRACT

A polymer includes a functional group that is photoswitchable between an open form and a closed form. The polymer may be used to recover a transition metal cation from a solution comprising the transition metal cation.

### CROSS-REFERENCE TO RELATED APPLICATIONS

This application claims priority to and the benefit of U.S. Provisional Patent Application No. 63/765,297, filed on Feb. 28, 2025, which is incorporated herein by reference in its entirety.

### GOVERNMENT RIGHTS

This invention was made with government support under Contract No. DE-AC02-06CH11357 awarded by the United States Department of Energy to UChicago Argonne, LLC, operator of Argonne National Laboratory. The government has certain rights in the invention.

### FIELD

The present technology is generally related to materials and method of recycling battery materials. In particular the present technology is related to photo-controlled recovery of transition metals from batteries.

### BACKGROUND

There is a large and rapidly growing market for Li-ion battery recycling technologies. There is an estimated 200 GWh of various Li-ion battery technologies in use within the transportation sector as of 2020. Li-ion battery recycling is expected to become a part of the Li-ion battery value chain over the next decade.

### SUMMARY

In one aspect, a polymer is disclosed including a functional group that is photoswitchable between a spiropyran form and a merocyanine form, a donor-acceptor Stenhouse adduct (DASA) functional group that is photoswitchable between a hexatrienol and a cyclopentenone, or a combination thereof.

In another aspect, a method is disclosed of recovering a transition metal cation from a solution comprising the transition metal cation. The method includes illuminating a polymer with a functional group with light having a wavelength of about 300 nm to about 450 nm to photoswitch the functional group from a spiropyran functional group to a merocyanine functional group or photoswitch the functional group from a hexatrienol functional group to a cyclopentenone functional group; and contacting the solution with the polymer comprising the merocyanine functional group or the cyclopentenone functional group, the merocyanine functional group configured to form a complex with the transition metal cation and the cyclopentenone functional group configured to form a complex with the transition metal cation.

In one embodiment, the polymer may be represented by any one or more of Formulae I, II, III, or IV:

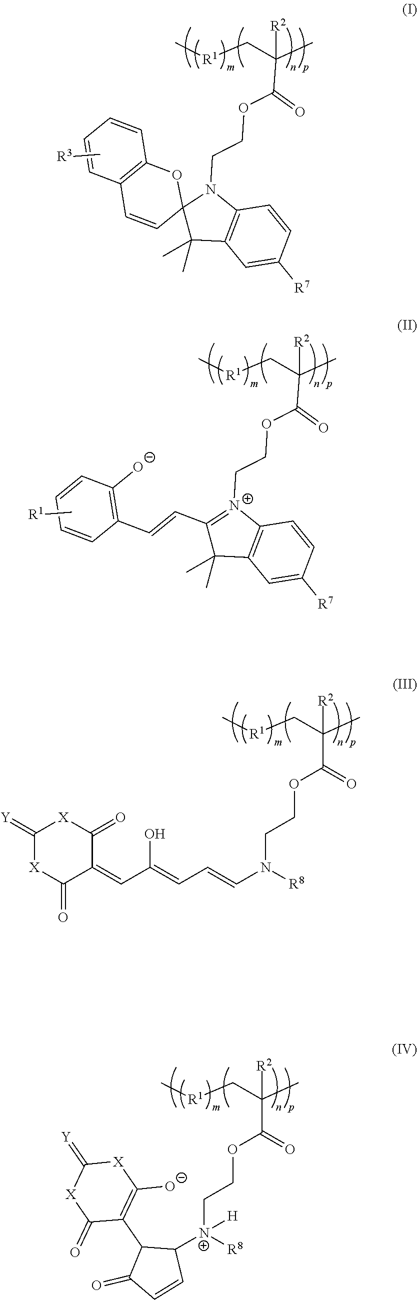

wherein:
R¹ is a group of formula:

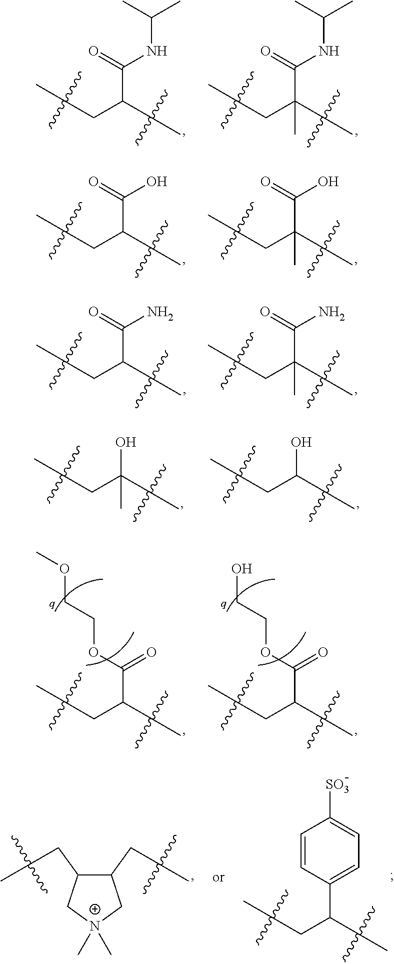

R² is H or C₁-C₆ alkyl;
R³ is H, alkyl, substituted alkyl, alkenyl, alkynyl, halogen, alkylcarboxylic acid, NO₂, OCH₃, N(CH₃)₂, CN, morpholine, alkylmorpholinyl, OH, NH₂, substituted bicyclic alkyl, or forms part of an aryl;
R⁷ is H, alkyl, substituted alkyl, alkenyl, alkynyl, halogen, NO₂, OCH₃, N(CH₃)₂, CN, morpholine, OH, NH₂, or substituted bicyclic alkyl;
R⁸ is H or alkyl;
X is N or O;
Y is O;
n is 1 to 1000;
m is 1 to 1000;
p is 1 to 1000; and
q is 1 to 5.

In another aspect, a polymer may be represented by Formula IA or Formula IIA:

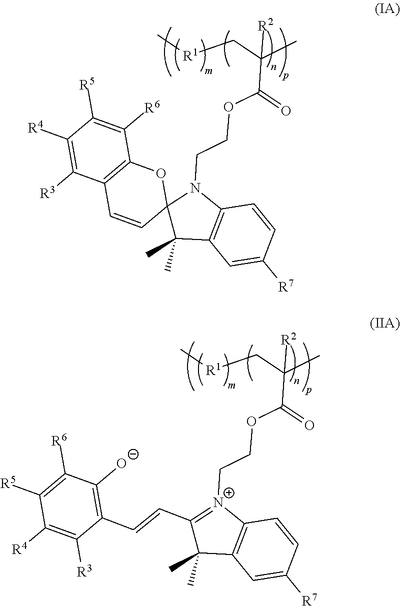

### Wherein:

R¹ is a group of formula:

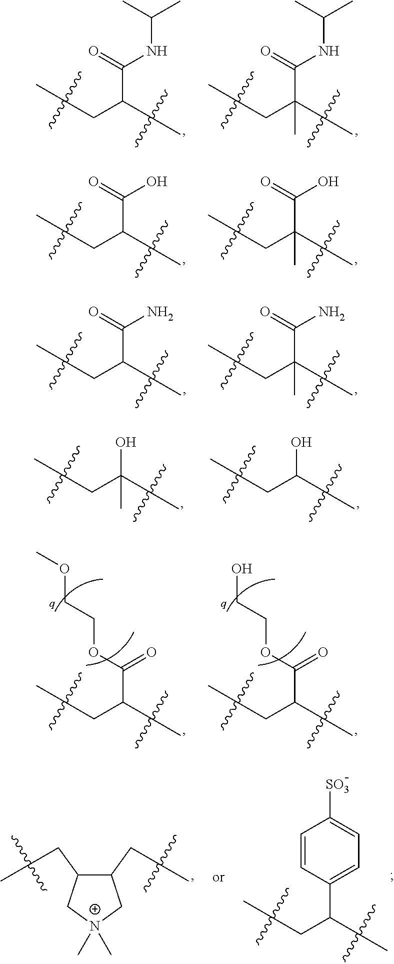

R² is H or alkyl;
R³ is H, alkyl, substituted alkyl, alkenyl, alkynyl, halogen, NO₂, OCH₃, N(R¹¹)₂,
CN, morpholine, OH, NH₂, substituted bicyclic alkyl, or R³ forms an aryl with R⁴;
R⁴ is H, alkyl, substituted alkyl, alkenyl, alkynyl, halogen, NO₂, OCH₃, N(R¹¹)₂, CN, morpholine, OH, NH₂, or substituted bicyclic alkyl, or R⁴ forms an aryl with R³ or R⁵;
R⁵ is H, alkyl, substituted alkyl, alkenyl, alkynyl, halogen, NO₂, OCH₃, N(R¹¹)₂, CN, morpholine, OH, NH₂, or substituted bicyclic alkyl, or R⁵ forms an aryl with R⁴ or R⁶;
R⁶ is H, alkyl, substituted alkyl, alkenyl, alkynyl, halogen, NO₂, OCH₃, N(R¹¹)₂, CN, morpholine, OH, NH₂, or substituted bicyclic alkyl,

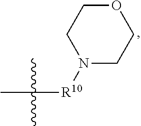

or R⁶ forms an aryl with R⁵;
R⁷ is H, alkyl, substituted alkyl, alkenyl, alkynyl, halogen, NO₂, OCH₃, N(R¹¹)₂, CN, morpholine, OH, NH₂, or substituted bicyclic alkyl;
R¹⁰ is C₁-C₆ alkylenyl;
R¹¹ is individually C₁-C₆ alkyl;
n is 1 to 1000;
m is 1 to 1000;
p is 1 to 1000; and
q is 1 to 5.

In some embodiments the polymers of Formula IA or Formula IIA may be represented stereospecifically as:

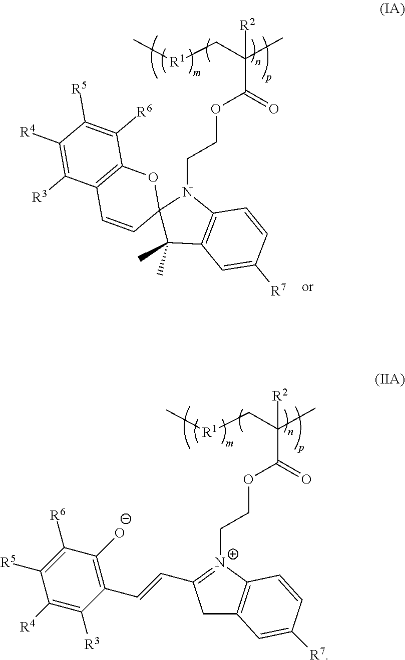

### BRIEF DESCRIPTION OF THE DRAWINGS

FIG. 1A is an illustration of photoswitching of a polymer functional group between a closed form and an open form, and FIG. 1B is an illustration of photoswitching of another polymer functional group between a closed form and an open form.

FIG. 2 is a flow diagram of capture and release of a transition metal cation from a polymer having a functional group that is photoswitchable between a closed form and an open form.

FIG. 3 is a flow diagram of recovery of a transition metal cation using a polymer having a functional group that is photoswitchable between a closed form and an open form.

FIG. 4 is a flow diagram of recovery of a transition metal cation from a polymer having a functional group that is photoswitchable between a closed form and an open form.

FIG. 5 is a reaction diagram for the formation of a homopolymer having a functional group that is photoswitchable between a spiropyran form and a merocyanine form.

FIG. 6 is a reaction diagram for the formation of a copolymer having a functional group that is photoswitchable between a spiropyran form and a merocyanine form.

FIG. 7A is a step-wise illustration of metal recover using the polymeric chelators, and FIG. 7B is a recovery graph showing that recovery of Ni, Mn, and Co, and that there is little to no cross-contamination across cycles, according to the examples.

FIGS. 8A and 8B, respectively, are UV-vis spectra showing improved binding ability for the polymer compared to the monomer, according to the examples.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

Generally, reference to a certain element such as hydrogen or H is meant to include all isotopes of that element. For example, if an R group is defined to include hydrogen or H, it also includes deuterium and tritium. Compounds comprising radioisotopes such as tritium, C¹⁴, P³² and S³⁵ are thus within the scope of the present technology. Procedures for inserting such labels into the compounds of the present technology will be readily apparent to those skilled in the art based on the disclosure herein.

In general, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group is substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, aryloxy, aralkyloxy, heterocyclyl, heterocyclylalkyl, heterocyclyloxy, and heterocyclylalkoxy groups; carbonyls (oxo); carboxylates; esters; urethanes; oximes; hydroxylamines; alkoxyamines; aralkoxyamines; thiols; sulfides; sulfoxides; sulfones; sulfonyls; pentafluorosulfanyl (i.e., SF5), sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; and nitriles (i.e., CN).

Substituted ring groups such as substituted cycloalkyl, aryl, heterocyclyl and heteroaryl groups also include rings and ring systems in which a bond to a hydrogen atom is replaced with a bond to a carbon atom. Therefore, substituted cycloalkyl, aryl, heterocyclyl and heteroaryl groups may also be substituted with substituted or unsubstituted alkyl, alkenyl, and alkynyl groups as defined below.

Alkyl groups include straight chain and branched chain alkyl groups having from 1 to 12 carbon atoms, and typically from 1 to 10 carbons or, in some embodiments, from 1 to 8, 1 to 6, or 1 to 4 carbon atoms. Alkyl groups may be substituted or unsubstituted. Examples of straight chain alkyl groups include groups such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above, and include without limitation haloalkyl (e.g., trifluoromethyl), hydroxyalkyl, thioalkyl, aminoalkyl, alkylaminoalkyl, dialkylaminoalkyl, alkoxyalkyl, carboxyalkyl, and the like.

Cycloalkyl groups include mono-, bi- or tricyclic alkyl groups having from 3 to 12 carbon atoms in the ring(s), or, in some embodiments, 3 to 10, 3 to 8, or 3 to 4, 5, or 6 carbon atoms. Cycloalkyl groups may be substituted or unsubstituted. Exemplary monocyclic cycloalkyl groups include, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Bi- and tricyclic ring systems include both bridged cycloalkyl groups and fused rings, such as, but not limited to, bicyclo[2.1.1]hexane, adamantyl, decalinyl, and the like.

Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Cycloalkylalkyl groups are alkyl groups as defined above in which a hydrogen or carbon bond of an alkyl group is replaced with a bond to a cycloalkyl group as defined above. Cycloalkylalkyl groups may be substituted or unsubstituted. In some embodiments, cycloalkylalkyl groups have from 4 to 16 carbon atoms, 4 to 12 carbon atoms, and typically 4 to 10 carbon atoms. Substituted cycloalkylalkyl groups may be substituted at the alkyl, the cycloalkyl or both the alkyl and cycloalkyl portions of the group. Representative substituted cycloalkylalkyl groups may be mono-substituted or substituted more than once, such as, but not limited to, mono-, di- or tri-substituted with substituents such as those listed above.

Alkenyl groups include straight and branched chain alkyl groups as defined above, except that at least one double bond exists between two carbon atoms. Alkenyl groups may be substituted or unsubstituted. Alkenyl groups have from 2 to 12 carbon atoms, and typically from 2 to 10 carbons or, in some embodiments, from 2 to 8, 2 to 6, or 2 to 4 carbon atoms. In some embodiments, the alkenyl group has one, two, or three carbon-carbon double bonds. Examples include, but are not limited to vinyl, allyl, —CH═CH(CH₃), —CH═C(CH₃)₂, —C(CH₃)—CH₂, —C(CH₃)═CH(CH₃), —C(CH₂CH₃)—CH₂, among others. Representative substituted alkenyl groups may be mono-substituted or substituted more than once, such as, but not limited to, mono-, di- or tri-substituted with substituents such as those listed above.

Cycloalkenyl groups include cycloalkyl groups as defined above, having at least one double bond between two carbon atoms. Cycloalkenyl groups may be substituted or unsubstituted. In some embodiments the cycloalkenyl group may have one, two or three double bonds but does not include aromatic compounds. Cycloalkenyl groups have from 4 to 14 carbon atoms, or, in some embodiments, 5 to 14 carbon atoms, 5 to 10 carbon atoms, or even 5, 6, 7, or 8 carbon atoms. Examples of cycloalkenyl groups include cyclohexenyl, cyclopentenyl, cyclohexadienyl, cyclobutadienyl, and cyclopentadienyl.

Cycloalkenylalkyl groups are alkyl groups as defined above in which a hydrogen or carbon bond of the alkyl group is replaced with a bond to a cycloalkenyl group as defined above. Cycloalkenylalkyl groups may be substituted or unsubstituted. Substituted cycloalkenylalkyl groups may be substituted at the alkyl, the cycloalkenyl or both the alkyl and cycloalkenyl portions of the group. Representative substituted cycloalkenylalkyl groups may be substituted one or more times with substituents such as those listed above.

Alkynyl groups include straight and branched chain alkyl groups as defined above, except that at least one triple bond exists between two carbon atoms. Alkynyl groups may be substituted or unsubstituted. Alkynyl groups have from 2 to 12 carbon atoms, and typically from 2 to 10 carbons or, in some embodiments, from 2 to 8, 2 to 6, or 2 to 4 carbon atoms. In some embodiments, the alkynyl group has one, two, or three carbon-carbon triple bonds. Examples include, but are not limited to —C≡CH, —C≡CCH₃, —CH₂C≡CCH₃, and —C≡CCH₂CH(CH₂CH₃)₂, among others. Representative substituted alkynyl groups may be mono-substituted or substituted more than once, such as, but not limited to, mono-, di- or tri-substituted with substituents such as those listed above.

Aryl groups are cyclic aromatic hydrocarbons that do not contain heteroatoms. Aryl groups herein include monocyclic, bicyclic, and tricyclic ring systems. Aryl groups may be substituted or unsubstituted. Thus, aryl groups include, but are not limited to, phenyl, azulenyl, heptalenyl, biphenyl, fluorenyl, phenanthrenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. In some embodiments, the aryl groups are phenyl or naphthyl. The phrase “aryl groups” includes groups containing fused rings, such as fused aromatic-aliphatic ring systems (e.g., indanyl, tetrahydronaphthyl, and the like). Representative substituted aryl groups may be mono-substituted (e.g., tolyl) or substituted more than once. For example, monosubstituted aryl groups include, but are not limited to, 2-, 3-, 4-, 5-, or 6-substituted phenyl or naphthyl groups, which may be substituted with substituents such as those listed above.

Aralkyl groups are alkyl groups as defined above in which a hydrogen or carbon bond of an alkyl group is replaced with a bond to an aryl group as defined above. Aralkyl groups may be substituted or unsubstituted. In some embodiments, aralkyl groups contain 7 to 16 carbon atoms, 7 to 14 carbon atoms, or 7 to 10 carbon atoms. Substituted aralkyl groups may be substituted at the alkyl, the aryl or both the alkyl and aryl portions of the group. Representative aralkyl groups include but are not limited to benzyl and phenethyl groups and fused (cycloalkylaryl)alkyl groups such as 4-indanylethyl. Representative substituted aralkyl groups may be substituted one or more times with substituents such as those listed above.

Heterocyclyl groups include aromatic (also referred to as heteroaryl) and non-aromatic ring compounds containing 3 or more ring members, of which one or more is a heteroatom such as, but not limited to, N, O, and S. Heterocyclyl groups may be substituted or unsubstituted. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass aromatic, partially unsaturated, and saturated ring systems, such as, for example, imidazolyl, imidazolinyl and imidazolidinyl groups. The phrase “heterocyclyl group” includes fused ring species including those comprising fused aromatic and non-aromatic groups, such as, for example, benzotriazolyl, 2,3-dihydrobenzo[1,4]dioxinyl, and benzo[1,3]dioxolyl. The phrase also includes bridged polycyclic ring systems containing a heteroatom such as, but not limited to, quinuclidyl. The phrase includes heterocyclyl groups that have other groups, such as alkyl, oxo or halo groups, bonded to one of the ring members, referred to as “substituted heterocyclyl groups.” Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl, azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups. Representative substituted heterocyclyl groups may be mono-substituted or substituted more than once, such as, but not limited to, pyridyl or morpholinyl groups, which are 2-, 3-, 4-, 5-, or 6-substituted, or disubstituted with various substituents such as those listed above.

Heteroaryl groups are aromatic ring compounds containing 5 or more ring members, of which, one or more is a heteroatom such as, but not limited to, N, O, and S. Heteroaryl groups may be substituted or unsubstituted. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. Representative substituted heteroaryl groups may be substituted one or more times with various substituents such as those listed above.

Heterocyclylalkyl groups are alkyl groups as defined above in which a hydrogen or carbon bond of an alkyl group is replaced with a bond to a heterocyclyl group as defined above. Heterocyclylalkyl groups may be substituted or unsubstituted. Substituted heterocyclylalkyl groups may be substituted at the alkyl, the heterocyclyl or both the alkyl and heterocyclyl portions of the group. Representative heterocyclyl alkyl groups include, but are not limited to, morpholin-4-yl-ethyl, furan-2-yl-methyl, imidazol-4-yl-methyl, pyridin-3-yl-methyl, tetrahydrofuran-2-yl-ethyl, and indol-2-yl-propyl. Representative substituted heterocyclylalkyl groups may be substituted one or more times with substituents such as those listed above.

Heteroaralkyl groups are alkyl groups as defined above in which a hydrogen or carbon bond of an alkyl group is replaced with a bond to a heteroaryl group as defined above. Heteroaralkyl groups may be substituted or unsubstituted. Substituted heteroaralkyl groups may be substituted at the alkyl, the heteroaryl or both the alkyl and heteroaryl portions of the group. Representative substituted heteroaralkyl groups may be substituted one or more times with substituents such as those listed above.

Groups described herein having two or more points of attachment (i.e., divalent, trivalent, or polyvalent) within the compound of the present technology are designated by use of the suffix, “ene.” For example, divalent alkyl groups are alkylene groups, divalent aryl groups are arylene groups, divalent heteroaryl groups are divalent heteroarylene groups, and so forth. Substituted groups having a single point of attachment to the compound of the present technology are not referred to using the “ene” designation. Thus, e.g., chloroethyl is not referred to herein as chloroethylene.

Alkoxy groups are hydroxyl groups (—OH) in which the bond to the hydrogen atom is replaced by a bond to a carbon atom of a substituted or unsubstituted alkyl group as defined above. Alkoxy groups may be substituted or unsubstituted. Examples of linear alkoxy groups include but are not limited to methoxy, ethoxy, propoxy, butoxy, pentoxy, hexoxy, and the like. Examples of branched alkoxy groups include but are not limited to isopropoxy, sec-butoxy, tert-butoxy, isopentoxy, isohexoxy, and the like. Examples of cycloalkoxy groups include but are not limited to cyclopropyloxy, cyclobutyloxy, cyclopentyloxy, cyclohexyloxy, and the like. Representative substituted alkoxy groups may be substituted one or more times with substituents such as those listed above.

The terms “alkanoyl” and “alkanoyloxy” as used herein can refer, respectively, to —C(O)-alkyl groups and —O—C(O)-alkyl groups, each containing 2-5 carbon atoms. Similarly, “aryloyl” and “aryloyloxy” refer to —C(O)-aryl groups and —O—C(O)-aryl groups.

The terms “aryloxy” and “arylalkoxy” refer to, respectively, a substituted or unsubstituted aryl group bonded to an oxygen atom and a substituted or unsubstituted aralkyl group bonded to the oxygen atom at the alkyl. Examples include but are not limited to phenoxy, naphthyloxy, and benzyloxy. Representative substituted aryloxy and arylalkoxy groups may be substituted one or more times with substituents such as those listed above.

The term “carboxylate” as used herein refers to a —COOH group.

The term “ester” as used herein refers to —COOR⁷⁰ and —C(O)O-G groups. R⁷⁰ is a substituted or unsubstituted alkyl, cycloalkyl, alkenyl, alkynyl, aryl, aralkyl, heterocyclylalkyl or heterocyclyl group as defined herein. G is a carboxylate protecting group. Carboxylate protecting groups are well known to one of ordinary skill in the art. An extensive list of protecting groups for the carboxylate group functionality may be found in Protective Groups in Organic Synthesis, Greene, T. W.; Wuts, P. G. M., John Wiley & Sons, New York, NY, (3rd Edition, 1999) which can be added or removed using the procedures set forth therein and which is hereby incorporated by reference in its entirety and for any and all purposes as if fully set forth herein.

The term “amide” (or “amido”) includes C- and N-amide groups, i.e., —C(O)NR⁷¹R⁷², and —NR⁷¹C(O)R⁷² groups, respectively. R⁷¹ and R⁷² are independently hydrogen, or a substituted or unsubstituted alkyl, alkenyl, alkynyl, cycloalkyl, aryl, aralkyl, heterocyclylalkyl or heterocyclyl group as defined herein. Amido groups therefore include but are not limited to carbamoyl groups (—C(O)NH₂) and formamide groups (—NHC(O)H). In some embodiments, the amide is —NR⁷¹C(O)—(C1-5 alkyl) and the group is termed “carbonylamino,” and in others the amide is —NHC(O)-alkyl and the group is termed “alkanoylamino.”

The term “amine” (or “amino”) as used herein refers to —NR⁷⁵R⁷⁶ groups, wherein R⁷⁵ and R⁷⁶ are independently hydrogen, or a substituted or unsubstituted alkyl, alkenyl, alkynyl, cycloalkyl, aryl, aralkyl, heterocyclylalkyl or heterocyclyl group as defined herein. In some embodiments, the amine is alkylamino, dialkylamino, arylamino, or alkylarylamino. In other embodiments, the amine is NH₂, methylamino, dimethylamino, ethylamino, diethylamino, propylamino, isopropylamino, phenylamino, or benzylamino.

The term “halogen” or “halo” as used herein refers to bromine, chlorine, fluorine, or iodine. In some embodiments, the halogen is fluorine. In other embodiments, the halogen is chlorine or bromine.

The term “hydroxyl” as used herein can refer to —OH or its ionized form, —O—. A “hydroxyalkyl” group is a hydroxyl-substituted alkyl group, such as HO—CH₂—.

The term “imide” refers to —C(O)NR⁹⁸C(O)R⁹⁹, wherein R⁹⁸ and R⁹⁹ are each independently hydrogen, or a substituted or unsubstituted alkyl, cycloalkyl, alkenyl, alkynyl, aryl aralkyl, heterocyclyl or heterocyclylalkyl group as defined herein.

The term “imine” refers to —CR¹⁰⁰(NR¹⁰¹) and —N(CR¹⁰⁰R¹⁰¹) groups, wherein R¹⁰⁰ and R¹⁰¹ are each independently hydrogen or a substituted or unsubstituted alkyl, cycloalkyl, alkenyl, alkynyl, aryl aralkyl, heterocyclyl or heterocyclylalkyl group as defined herein, with the proviso that R¹⁰⁰ and R¹⁰¹ are not both simultaneously hydrogen.

The term “nitro” as used herein refers to an —NO₂ group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 atoms refers to groups having 1, 2, or 3 atoms. Similarly, a group having 1-5 atoms refers to groups having 1, 2, 3, 4, or 5 atoms, and so forth.

As understood by one of ordinary skill in the art, “molecular weight” (also known as “relative molar mass”) is a dimensionless quantity but is converted to molar mass by multiplying by 1 gram/mole or by multiplying by 1 Da—for example, a compound with a weight-average molecular weight of 5,000 has a weight-average molar mass of 5,000 g/mol and a weight-average molar mass of 5,000 Da.

Those of skill in the art will appreciate that compounds of the present technology may exhibit the phenomena of tautomerism, conformational isomerism, geometric isomerism, and/or stereoisomerism. As the formula drawings within the specification and claims can represent only one of the possible tautomeric, conformational isomeric, stereochemical or geometric isomeric forms, it should be understood that the present technology encompasses any tautomeric, conformational isomeric, stereochemical and/or geometric isomeric forms of the compounds having one or more of the utilities described herein, as well as mixtures of these various different forms.

“Tautomers” refers to isomeric forms of a compound that are in equilibrium with each other. The presence and concentrations of the isomeric forms will depend on the environment the compound is found in and may be different depending upon, for example, whether the compound is a solid or is in an organic or aqueous solution. For example, in aqueous solution, quinazolinones may exhibit the following isomeric forms, which are referred to as tautomers of each other:

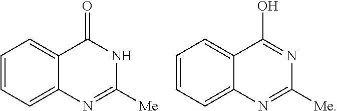

As another example, guanidines may exhibit the following isomeric forms in protic organic solution, also referred to as tautomers of each other:

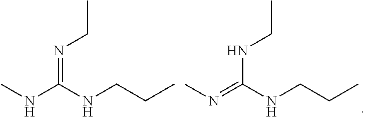

Because of the limits of representing compounds by structural formulas, it is to be understood that all chemical formulas of the compounds described herein represent all tautomeric forms of compounds and are within the scope of the present technology.

Stereoisomers of compounds (also known as optical isomers) include all chiral, diastereomeric, and racemic forms of a structure, unless the specific stereochemistry is expressly indicated. Thus, compounds used in the present technology include enriched or resolved optical isomers at any or all asymmetric atoms as are apparent from the depictions. Both racemic and diastereomeric mixtures, as well as the individual optical isomers can be isolated or synthesized so as to be substantially free of their enantiomeric or diastereomeric partners, and these stereoisomers are all within the scope of the present technology.

The compounds of the present technology may exist as solvates, especially hydrates. Hydrates may form during manufacture of the compounds or compositions comprising the compounds, or hydrates may form over time due to the hygroscopic nature of the compounds. Compounds of the present technology may exist as organic solvates as well, including DMF, ether, and alcohol solvates, among others. The identification and preparation of any particular solvate is within the skill of the ordinary artisan of synthetic organic chemistry.

Recycling lithium-ion (Li-ion) batteries may include several steps to recover valuable materials. Recycling typically includes the collection and sorting of used or defective batteries. Once collected, the batteries may be discharged to prevent or reduce risk of fire or explosion. The electrolyte from the batteries may be collected and the rest of the battery materials may be mechanically shredded. The shredded materials may undergo processing to extract valuable transition metals, including manganese, copper, cobalt, and nickel. These metals may be reused in the production of new batteries or other products, thereby conserving natural resources and reducing the environmental impact of battery waste.

However, conventional processing used to extract transition metals from the Li-ion batteries may be resource-intensive and complex. The processes typically include energy-intensive steps and caustic treatments. For example conventional processing may include higher temperature treatments and/or the use of strong acids. Furthermore, these processes typically have low recovery rates and may be incompatible with large-scale processing.

Disclosed herein are materials for the recovery of transition metals, methods using these materials, and methods of making these materials. The materials may recover transition metal cations from solution. The solution including transition metal cations may be a solution formed from treatment of shredded battery materials, may be an electrolyte solution, or a combination thereof. The materials may be polymers with functional groups that may reversibly form complexes with transition metal cations, so that the polymers may be reusable. The reversible complexation may be photoresponsive, with light illumination prompting a structural change in the functional groups that promotes complexation or disassociation, depending on the wavelength of light.

The transition metals that may be recovered include those that may be used in cathode materials of Li-ion batteries. For example, the transition metals may include, without limitation, nickel, cobalt, manganese, or a combination of any two or more thereof.

In an aspect, the material may include a polymer including a functional group for photoresponsive recovery of a transition metal cation. The functional group may be photoswitchable between a closed form that does not form a complex with the transition metal cation and an open form that does form a complex with the transition metal cation. By photoswitching between the open and closed forms, the polymer may capture and release, respectively, the transition metal cation. As an example, the functional group may be a spiropyran functional group where the closed form is a spiropyran and the open form is a merocyanine. In this example, the functional group may be photoswitchable between the spiropyran form and the merocyanine form. As another example, the functional group may be a donor-acceptor Stenhouse adduct (DASA) functional group where the closed form is a hexatrienol and the open form is a cyclopentenone. In this example, the functional group may be photoswitchable between the hexatrienol and the cyclopentenone. As another example, the polymer may include both spiropyran and DASA functional groups. As a further example, the functional group may be a bipyridine. The DASA and bipyridine structures many be illustrated as:

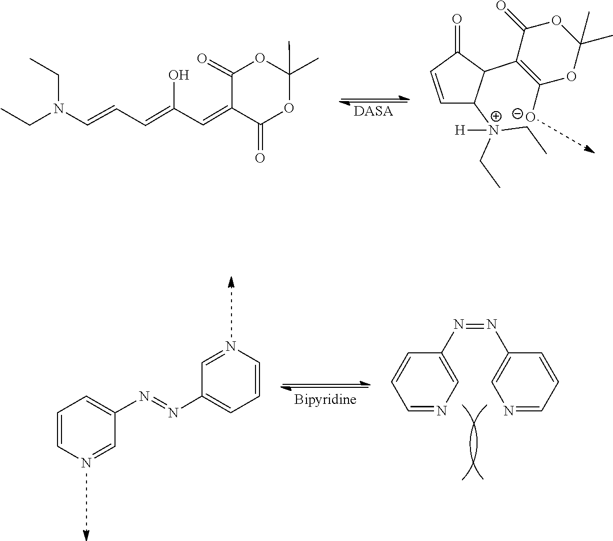

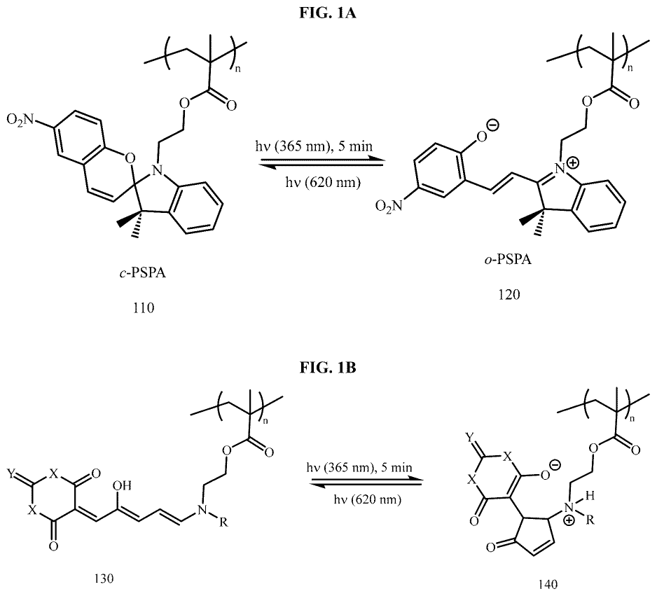

FIG. 1A is an illustration of photoswitching of a polymer functional group between a spiropyran form 110 and a merocyanine form 120. The spiropyran form 110 may be a closed version of the functional group, where the closed version does not form a complex with transition metal cations. The merocyanine form 120 may be an open version of the functional group, where the open version is able to form complexes with the transition metal cations. The functional group may convert from the spiropyran form 110 to the merocyanine form 120 upon illumination of the polymer with light having a wavelength of about 300 nm to about 450 nm (e.g., about 320 nm to about 420 nm, about 330 nm to about 400 nm, about 350 nm to about 380 nm, about 360 nm to about 370 nm, or about 365 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween).

The spiropyran form 110 may be a more stable form of the functional group, and the functional may convert from the merocyanine form 120 to the spiropyran form 110 over time (e.g., about 1 hour, about 6 hours, about 12 hours, about 24 hours, about 48 hours, or longer) under ambient light (e.g., about 300 nm to about 900 nm, about 350 nm to about 650 nm, or any value or subrange therebetween). Additionally or alternatively, the functional group may photoswitch from the merocyanine form 120 to the spiropyran form 110 upon illumination of the polymer with light having a wavelength of about 550 nm to about 700 nm (e.g., about 560 nm to about 690 nm, about 570 nm to about 680 nm, about 580 nm to about 670 nm, about 590 nm to about 660 nm, about 600 nm to about 650 nm, about 600 nm to about 640 nm, about 610 nm to about 630 nm, about 620 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween).

FIG. 1B is an illustration of photoswitching of a DASA polymer functional group between a hexatrienol form 130 and a cyclopentenone form 140. The DASA polymer functional group may act in a similar way to the spiropyran functional group.

The hexatrienol form 130 may be a closed version of the functional group, where the closed version does not form a complex with transition metal cations. The cyclopentenone form 140 may be an open version of the functional group, where the open version is able to form complexes with the transition metal cations. The functional group may convert from the hexatrienol form 130 to the cyclopentenone form 140 upon illumination of the polymer with light having a wavelength of about 300 nm to about 450 nm (e.g., about 320 nm to about 420 nm, about 330 nm to about 400 nm, about 350 nm to about 380 nm, about 360 nm to about 370 nm, or about 365 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween).

The hexatrienol form 130 may be a more stable form of the functional group, and the functional may convert from the cyclopentenone form 140 to the hexatrienol form 130 over time (e.g., about 1 hour, about 6 hours, about 12 hours, about 24 hours, about 48 hours, or longer) under ambient light (e.g., about 300 nm to about 900 nm, about 350 nm to about 650 nm, or any value or subrange therebetween). Additionally or alternatively, the functional group may photoswitch from the cyclopentenone form 140 to the hexatrienol form 130 upon illumination of the polymer with light having a wavelength of about 550 nm to about 700 nm (e.g., about 560 nm to about 690 nm, about 570 nm to about 680 nm, about 580 nm to about 670 nm, about 590 nm to about 660 nm, about 600 nm to about 650 nm, about 600 nm to about 640 nm, about 610 nm to about 630 nm, about 620 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween).

The polymer may include a backbone including polyethylene, polysiloxanes, polypropylene, polyamide, or a combination of any two or more thereof. For example, the polymer may include a polyethylene backbone, a polyamide backbone, or a combination thereof.

The polymer may be represented by any one or more of Formulae I, II, III, and IV:

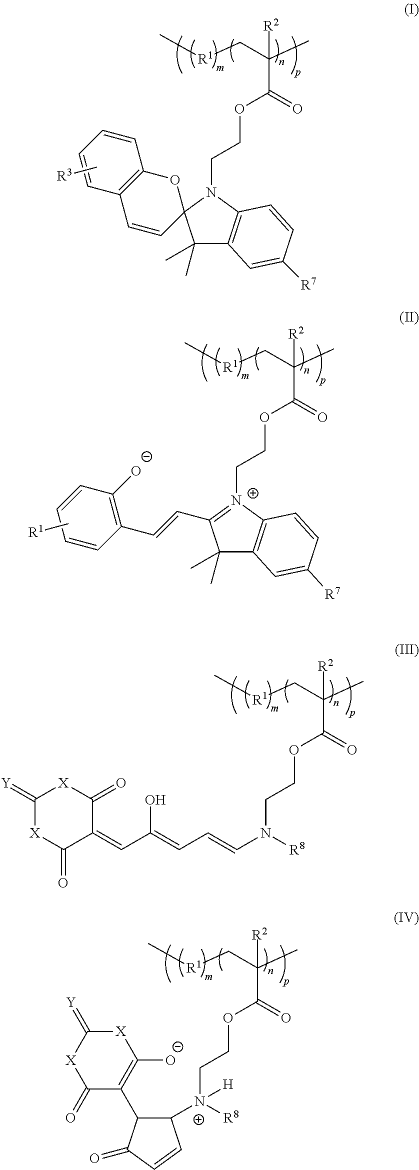

wherein:
R¹ is a group of formula:

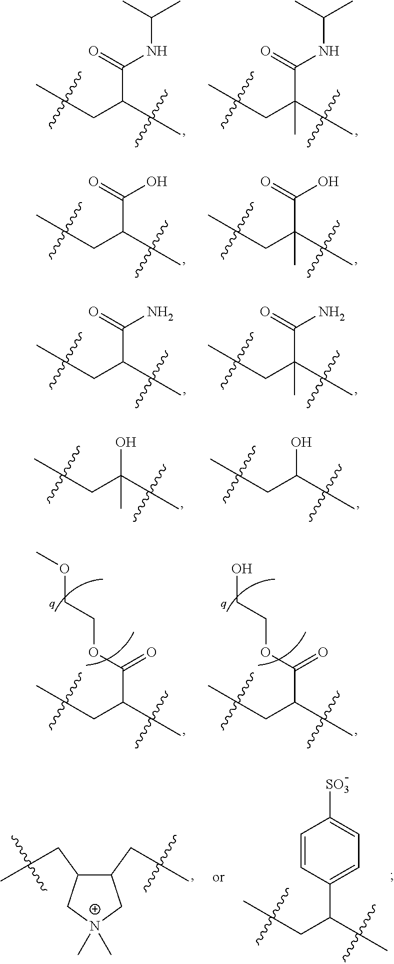

R² is H or C₁-C₆ alkyl;
R³ is H, alkyl, substituted alkyl, alkenyl, alkynyl, halogen, alkylcarboxylic acid, NO₂, OCH₃, N(CH₃)₂, CN, morpholine, alkylmorpholinyl, OH, NH₂, substituted bicyclic alkyl, or forms part of an aryl;
R⁷ is H, alkyl, substituted alkyl, alkenyl, alkynyl, halogen, NO₂, OCH₃, N(CH₃)₂, CN, morpholine, OH, NH₂, or substituted bicyclic alkyl;
R⁸ is H or alkyl;
X is N or O;
Y is O;
n is 1 to 1000;
m is 1 to 1000;
p is 1 to 1000; and
q is 1 to 5.

The structure of Formula I is a spiropyran form and the structure of Formula II is a merocyanine form. The polymer may switch between the structure of Formula I and the structure of Formula II upon light illumination according to the features of the polymer described with respect to FIG. 1A.

The structure of Formula III is a hexatrienol form and the structure of Formula IV is a cyclopentenone form. The polymer may switch between the structure of Formula III and the structure of Formula IV upon light illumination according to the features of the polymer described with respect to FIG. 1B.

R¹ may be formed from N-isopropylacrylamide (NIPAM), N-isopropylmethacrylamide (NIPMAM), acrylic acid, methacrylic acid, acrylamide, methacrylamide monomers, vinyl alcohol, or ethylene glycol, depending on the structure of R¹.

In any embodiment, it may be that the ratio of min is about 1:1 to about 100:1 (e.g., about 1:1 to about 50:1, about 1:1 to about 20:1, about 4:1 to about 20:1, about 2:1 to about 6:1, about 10:1 to about 30:1, or any value or subrange therebetween). For example, the ratio of m:n may be about 4:1 to about 20:1. For example, the ratio of min may be about 4:1. For example, the ratio of min may be bout 20:1. For example, the ratio of min may be bout 10:1.

In any embodiment, it may be that the polymer has an average molecular weight of about 4400 Da to about 90000 Da (e.g., about 4400 Da to about 80000 Da, about 5000 Da to about 8000 Da, about 6000 Da to about 7000 Da, about 6000 Da to about 50000 Da, about 20000 Da to about 60000 Da, about 40000 Da to about 60000 Da, about 40000 Da to about 50000 Da). For example, the average molecular weight may be about 6800 Da. For example, the average molecular weight may be about 44900 Da.

In any embodiment, it may be that the polymer has a polydispersity index (PDI), used as a measure of broadness of molecular weight distribution, of about 1 to about 10 (e.g., about 2 to about 10, about 3 to about 10, about 4 to about 10, about 4 to about 8, about 5 to about 8, about 6 to about 7). For example, the PDI may be about 6.6.

The polymer may have a structural unit according to Formula IA or a structural unit according to Formula IIA

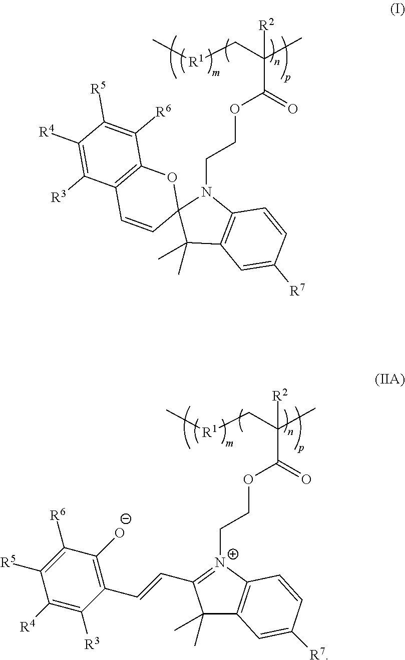

wherein:
R¹ is a group of formula:

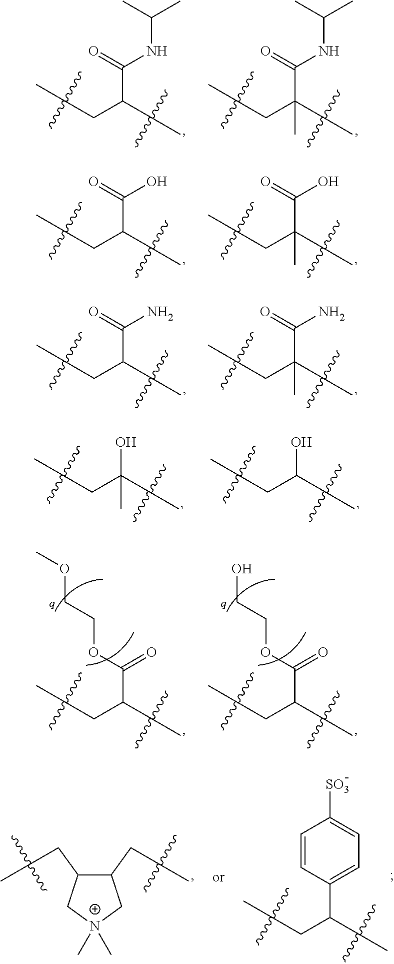

R² is H or alkyl;
R³ is H, alkyl, substituted alkyl, alkenyl, alkynyl, halogen, NO₂, OCH₃, N(R¹¹)₂, CN, morpholine, OH, NH₂, substituted bicyclic alkyl, or R³ forms an aryl with R⁴;
R⁴ is H, alkyl, substituted alkyl, alkenyl, alkynyl, halogen, NO₂, OCH₃, N(R¹¹)₂, CN, morpholine, OH, NH₂, or substituted bicyclic alkyl, or R⁴ forms an aryl with R³ or R⁵;
R⁵ is H, alkyl, substituted alkyl, alkenyl, alkynyl, halogen, NO₂, OCH₃, N(R¹¹)₂, CN, morpholine, OH, NH₂, or substituted bicyclic alkyl, or R⁵ forms an aryl with R⁴ or R⁶;
R⁶ is H, alkyl, substituted alkyl, alkenyl, alkynyl, halogen, NO₂, OCH₃, N(R¹¹)₂, CN, morpholine, OH, NH₂, or substituted bicyclic alkyl,

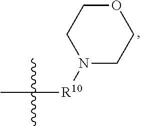

or R⁶ forms an aryl with R⁵;
R⁷ is H, alkyl, substituted alkyl, alkenyl, alkynyl, halogen, NO₂, OCH₃, N(R¹¹)₂, CN, morpholine, OH, NH₂, or substituted bicyclic alkyl;
R¹⁰ is C₁-C₆ alkylenyl;
R¹¹ is individually C₁-C₆ alkyl;
n is 1 to 1000;
m is 1 to 1000;
p is 1 to 1000; and
q is 1 to 5.

Where any of R³, R⁴, R⁵, R⁶, and R⁷ is an alkyl, the alkyl may be a C₁-C₁₀ alkyl, C₁-C₅ alkyl, C₁-C₄ alkyl, CH₃, CH₂CH₃, CH₂CH₂CH₃, or CH₂CH₂CH₂CH₃. The alkyl may be a branched alkyl. The alkyl may be a linear alkyl. The alkyl may be a cyclic alkyl.

Where any of R³, R⁴, R⁵, R⁶, and R⁷ is an alkenyl, the alkenyl may be a C₁-C₁₀ alkenyl, C₁-C₅ alkenyl, C₁-C₄ alkenyl, CH₃, CH₂CH₃, CH₂CH₂CH₃, or CH₂CH₂CH₂CH₃. The alkenyl may be a branched alkenyl. The alkenyl may be a linear alkenyl. The alkenyl may be a cyclic alkenyl.

Where any of R³, R⁴, R⁵, R⁶, and R⁷ is an alkynyl, the alkynyl may be a C₁-C₁₀ alkynyl, C₁-C₅ alkynyl, C₁-C₄ alkynyl, CH₃, CH₂CH₃, CH₂CH₂CH₃, or CH₂CH₂CH₂CH₃. The alkynyl may be a branched alkynyl. The alkynyl may be a linear alkynyl.

Where any of R³, R⁴, R⁵, R⁶, and R⁷ is a substituted alkyl, the alkyl may be substituted with CN, NO₂, alkyl, aryl, or one or more halogens (e.g., F, Cl, Br, I, or a combination of any two or more thereof). In some embodiments, the substituted alkyl may be a linear alkyl substituted with a halogen. In some embodiments, the substituted alkyl may be a branched alkyl substituted with a halogen. In some embodiments, the substituted alkyl may be a cyclic alkyl substituted with a halogen.

In some embodiments, the polymer may be represented as a spiropyran or merocyaninine, respectively as:

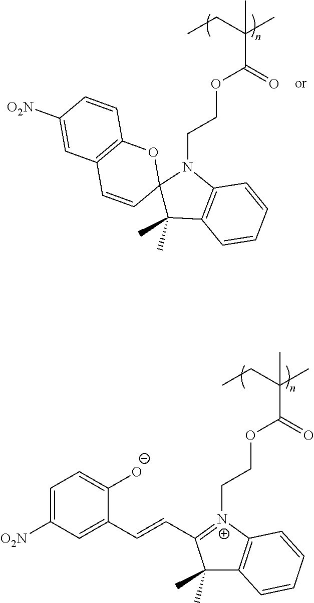

where n is 1 to 10000.

The polymer may switch between the two forms upon light illumination according to the features of the polymer described with respect to FIG. 1A.

In another aspect, a method of recovering a transition metal cation is disclosed. The method may include contacting the transition metal cation with any of the polymers disclosed herein. Contacting the transition metal cation with the polymer may form a complex comprising the polymer's photoswitchable functional group and the transition metal cation.

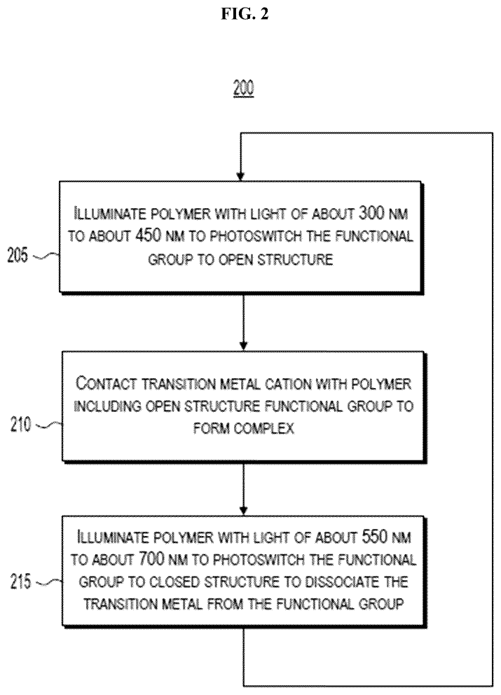

FIG. 2 is a flow diagram of a method 200 of capture and release of a transition metal cation from a polymer having a functional group that is photoswitchable between a closed form and an open form.

Step 205 includes illuminating the polymer with light having a wavelength of about 300 nm to about 450 nm (e.g., about 320 nm to about 420 nm, about 330 nm to about 400 nm, about 350 nm to about 380 nm, about 360 nm to about 370 nm, or about 365 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween) to photoswitch a functional group of the polymer from a closed form to an open form. The polymer may be dissolved or suspended in a polar solvent (e.g., water, aqueous solution with a pH of about 5 to about 8, ethyl acetate, dimethylformamide (DMF), dimethyl carbonate (DMC), ethanol, methanol, acetone, acetonitrile, or a combination of any two or more thereof), or the polymer may be in solid form or partially dissolved or partially suspended in the polar solvent.

Step 210 includes contacting the transition metal cation with the polymer including the open form functional group to form a complex including the transition metal cation and the functional group. The transition metal cation may be dissolved in the polar solvent. The complex may be formed through electrostatic interactions between the transition metal cation and the functional group. Step 210 may be conducted soon (e.g., about 1 hour, about 6 hours, about 12 hours, about 24 hours, about 48 hours, or longer) after step 205.

Step 215 includes illuminating the polymer with light having a wavelength of about 550 nm to about 700 nm (e.g., about 560 nm to about 690 nm, about 570 nm to about 680 nm, about 580 nm to about 670 nm, about 590 nm to about 660 nm, about 600 nm to about 650 nm, about 600 nm to about 640 nm, about 610 nm to about 630 nm, about 620 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween) to photoswitch the polymer functional group from the open form to the closed form to decomplex the transition metal from the functional group. Step 215 may be conducted while the transition metal cation and the polymer are in the same the solvent used in step 205 or a different solvent. Where a different solvent is used, the method 200 may include isolating the polymer including the transition metal cation complex and resuspending the polymer in a different solution in which the transition metal cation is decomplexed from the polymer.

The method 200 may include repeating steps 205, 210, and 215 a number of times (e.g., 1 to 100 times, 1 to 50 times, 1 to 20 times, 1 to 10 times, or any value or subrange therebetween).

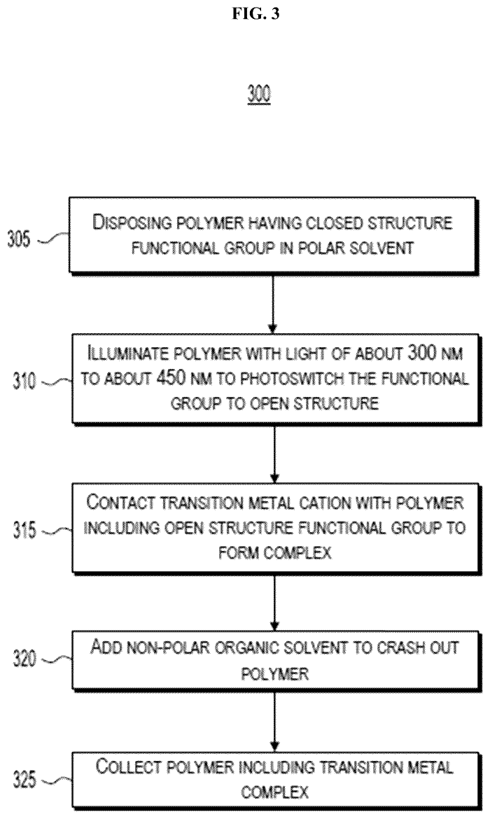

FIG. 3 is a flow diagram of a method 300 for recovery of a transition metal cation using a polymer having a functional group that is photoswitchable between a closed form and an open form. The polymer may be any of the polymers disclosed herein.

Step 305 includes disposing the polymer in a first solvent. The first solvent may be a polar solvent. Nonlimiting examples of the polar solvent include water, aqueous solution with a pH of about 5 to about 8, ethyl acetate, dimethylformamide (DMF), dimethyl carbonate (DMC), ethanol, methanol, acetone, acetonitrile, or a combination of any two or more thereof. The polymer may be dissolved or suspended in the first solvent or the polymer may be in solid form or partially dissolved or partially suspended in the first solvent.

Step 310 includes illuminating the polymer with light having a wavelength of about 300 nm to about 450 nm (e.g., about 320 nm to about 420 nm, about 330 nm to about 400 nm, about 350 nm to about 380 nm, about 360 nm to about 370 nm, or about 365 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween) to photoswitch a functional group of the polymer from a closed form to an open form.

Step 315 includes contacting the transition metal cation with the polymer including the open form functional group to form a complex including the transition metal cation and the functional group. The complex may be formed through electrostatic interactions between the transition metal cation and the open form functional group. Step 315 may be conducted soon (e.g., about 1 hour, about 6 hours, about 12 hours, about 24 hours, about 48 hours, or longer) after step 310.

Step 320 includes adding a second solvent to crash out the polymer from the first solvent. The second solvent may be less polar than the first solvent (e.g., a non-polar solvent). For example, the first solvent may be ethyl acetate and the second solvent may be diethyl ether. Where the polymer is a solid or partially soluble in the first solvent, the method 300 may not include step 320.

Step 325 includes collecting the polymer including the transition metal complex. Collecting the polymer may include any suitable technique for separating a solid from a liquid. For example, collecting the polymer may include centrifuging the polymer in the first solvent, or the combination of the first solvent and the second solvent to form a solid pellet of the polymer. Additionally or alternatively, collecting the polymer may include filtering the polymer from the first solvent or the combination of the first solvent and the second solvent. Collecting the polymer may include drying the polymer to remove the first solvent or the combination of the first solvent and the second solvent.

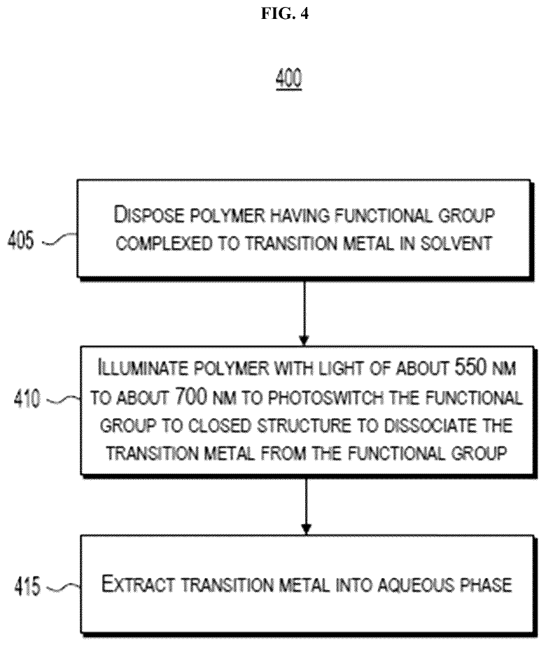

FIG. 4 is a flow diagram of a method 400 of recovery of a transition metal cation from any of the polymers disclosed herein including the transition metal complex. Step 405 of the method 400 may follow step 325 of the method 300.

Step 405 includes disposing the polymer including the transition metal complex in a solvent. The solvent may be a polar solvent. Nonlimiting examples of the polar solvent include water, aqueous solution with a pH of about 5 to about 8, ethyl acetate, dimethylformamide (DMF), dimethyl carbonate (DMC), ethanol, methanol, acetone, acetonitrile, or a combination of any two or more thereof.

Step 410 includes illuminating the polymer with light having a wavelength of about 550 nm to about 700 nm (e.g., about 560 nm to about 690 nm, about 570 nm to about 680 nm, about 580 nm to about 670 nm, about 590 nm to about 660 nm, about 600 nm to about 650 nm, about 600 nm to about 640 nm, about 610 nm to about 630 nm, about 620 nm, or any value or subrange therebetween) for a period of time (e.g., at least about 1 minute to about 1 hour, about 2 minutes to about 30 minutes, about 2 minutes to about 15 minutes, about 2 minutes to about 10 minutes, about 2 minutes to about 8 minutes, or about 5 minutes, or any value or subrange therebetween) to photoswitch the polymer functional group from the open form to the closed form to decomplex the transition metal from the functional group.

Step 415 includes extracting the transition metal cation dissociated from the polymer. Extracting the transition metal cation may include polar extraction. Polar extraction may include using two immiscible liquids, one a more polar solvent and the other a less polar solvent to separate the transition metal cation into the more polar solvent while the polymer remains in the less polar solvent. Extraction may result in a solution of the transition metal cation. Once the transition metal cation is extracted, the polymer may be isolated for reuse as described herein.

The present invention, thus generally described, will be understood more readily by reference to the following examples, which are provided by way of illustration and are not intended to be limiting of the present invention.

### Examples

### Example 1: Synthesis and Characterization of the Homopolymer

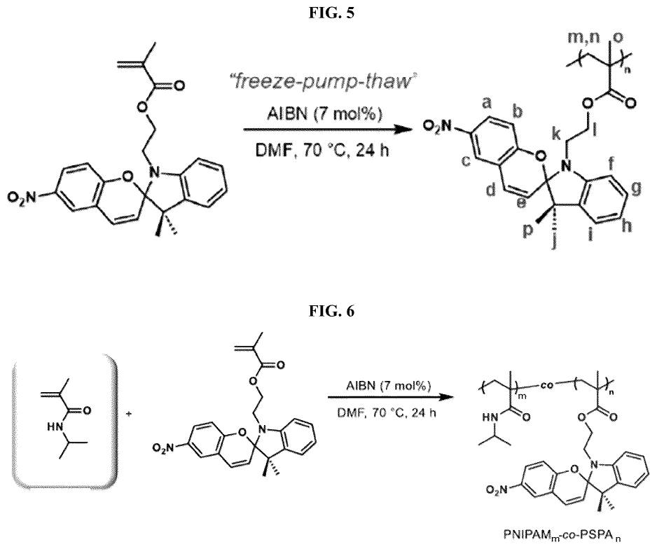

FIG. 5 is a reaction diagram for the formation of a homopolymer having a functional group that is photoswitchable between a spiropyran form and a merocyanine form. Synthesis included using 7 mol. % azobisisobutyronitrile (AIBN) in DMF at 70° C. for 24 hours to initiate free-radical polymerization of the spiropyran monomer and form the spiropyran homopolymer. The spiropyran homopolymer had a Mn of 6800, Mw of 44900, and a PDI of 6.6 as measured by gel permeation chromatography (GPC).

The spiropyran homopolymer was characterized with 1H nuclear magnetic resonance (NMR). ¹H NMR (300 MHz, CDCl3) δ 7.88 (Hₐ, H_{c}), 7.02-6.58 (H_{b}, Hₐ, H_{f}, H_{g}, Hₕ, Hᵢ), 5.75 (Hₑ), 3.95 (Hₗ), 3.32 (Hₖ), 1.60 (Hₒ), 1.08-0.75 (Hⱼ, Hₘ, Hₙ, Hₚ) ppm.

Mixing the spiropyran homopolymer with water formed suspension of red particles of polymer suspended in solution. Irradiation of the suspension at 365 nm for 5 minutes resulted in a color change from red to purple, indicating photoisomerization of the homopolymer from the spiropyran form to the merocyanine form. The purple suspension of polymer was filtered, resulting in solid particles of merocyanine homopolymer that were purple in color.

To characterize transition metal capture, the spiropyran homopolymer was suspended in an aqueous solution of CoCl₂, Mn(NO₃)₂, and NiCl₂. The suspension was illuminated at 365 nm for 5 minutes to convert the polymer spiropyran functional groups to merocyanine functional groups, and to form complexes of the polymer with the transition metal cations Co²⁺, Mn²⁺, and Ni²⁺. Results of complexation were characterized with ion chromatography (IC) to measure amounts of the transition metals in the aqueous solutions. Results are shown in Table 1 and did not indicate substantial capture of the transition metal cations. Without being bound by any theory, it was speculated that the lack of capture may be related to low solubility of the polymer in aqueous solution.

TABLE 1
Ion chromatography concentration of transition
metal cations in aqueous polymer suspensions.

| | Transition Metal | Transition Metal |
|---|---|---|
| | Concentration | Concentration |
| Transition | in Spiropyran | in Merocyanine |
| Metal | Homopolymer Suspension | Homopolymer Suspension |
| Co²⁺ | 6.7 | 7.4 |
| Mn²⁺ | 3.4 | 3.5 |
| Ni²⁺ | 3.9 | 3.5 |

Solubility of the homopolymer showed poor solubility in polar solvent, including water, DMC, ethanol, methanol, and acetone, as characterized visually by suspending the polymer in solution and agitating.

### Example 2: Synthesis and Characterization of the Copolymer

FIG. 6 is a reaction diagram of the formation of a copolymer having a functional group that is photoswitchable between a spiropyran form and a merocyanine form. Synthesis included using 7 mol. % AIBN in DMF at 70° C. for 24 hours to initiate free-radical polymerization of the copolymer. The copolymer was synthesized with different equivalents of min of the monomer including the photoswitchable functional group and N-isopropylmethacrylamide (NIPMAM). The different equivalents men were 4:1, 10:1, and 20:1 of NIPMAM to photoswitchable monomer. The copolymer may have a structure according to Formula XXI in the spiropyran form, and/or a structure according to Formula XXII in the merocyanine form:

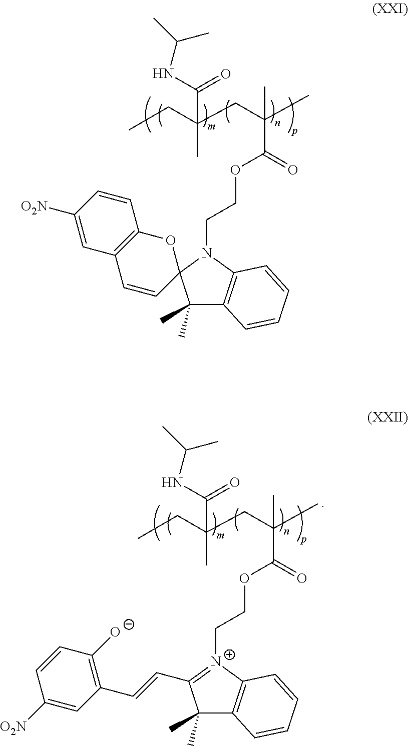

The spiropyran copolymer was characterized with ¹H NMR. ¹H NMR (300 MHz, CDCl₃) δ 7.88 (Hₐ, H_{c}), 7.02-6.58 (H_{b}, Hₐ, H_{f}, H_{g}, Hₙ, Hᵢ), 5.75 (Hₑ), 5.61 (NIPMAM), 3.95-3.91 (Hₗ, NIPMAM), 3.32 (Hₖ), 1.60 (Hₒ, NIPMAM), 1.08-0.75 (Hⱼ, Hₘ, Hₙ, Hₚ, NIPMAM) ppm.

There were differences in solubility of the copolymer in polar solvent depending on the min equivalent ratio, as characterized visually by suspending the polymer in solution and agitating. The copolymer with 4:1 equivalent ratio of NIPMAM to photoswitchable monomer indicated solubility in acetone and partial solubility in DMC, ethanol, and methanol. The copolymer with 20:1 equivalent ratio of NIPMAM to photoswitchable monomer indicated solubility in ethanol, methanol, and acetone, and partial solubility in water and DMC.

The solutions of 20:1 copolymer were irradiated at 365 nm for 5 minutes, resulting in a color change from orange to purple, indicating photoisomerization from the spiropyran form to the merocyanine form.

The structure of the copolymer in the presence of a transition metal cation was compared to that of the copolymer not in the presence of the transition metal cation using ¹NMR. The copolymer was characterized in both the spiropyran form and the merocyanine form. The transition metal cation was Co²⁺ from a solution of CoCl₂. Results did not indicate an obvious chemical shift in ¹NMR, indicating little to no coordination.

### Example 3: Transition Metal Capture

The transition metal capture of the copolymer was characterized. The copolymer in the spiropyran form was dissolved in ethyl acetate. The solution of copolymer was irradiated at 365 nm for 5 minutes, prompting a change in color of the solution from orange to purple, indicating photoisomerization from the spiropyran form to the merocyanine form. A solution of Mn(NO₃)₂ in ethyl acetate was added to the solution of copolymer in the merocyanine form, forming a precipitate and prompting a color change of the solution from purple to red. The polymer was further crashed out by the addition of diethyl ether. The polymer was filtered to isolate the polymer with the manganese cation complex. The polymer was characterized by inductively coupled mass spectroscopy (ICP-MS) to determine manganese content. ICP-MS indicated a manganese concentration of about 127 μg in a sample of the polymer with a total mass of 0.01804 g. The manganese cations were dissociated from the polymer using a polar extraction with water and dichloromethane (DCM) solvents. The water phase was characterized with IC following extraction. IC indicated a peak matching with a Mn standard, suggesting the release of Mn via extraction.

The reusability of the copolymer for recovering transition metal cations was characterized. The copolymer had a 10:1 equivalent m:n. Transition metal cation capture was characterized by consecutive metal capture and release with Ni²⁺, Mn²⁺, or Co²⁺. The copolymer was dissolved in ethyl acetate, and then irradiated at 365 nm for 5 minutes, followed by the addition of the transition metal solution. The polymer was precipitated with diethyl ether and then centrifuge to isolate the polymer. The transition metal was then extracted from the polymer by illumination with light at 620 nm and polar extraction. This process of capture and release of the transition metal cations was repeated. The amount of transition metal in the aqueous phase following extraction for each iteration was quantified with IC. Results are shown in Table 2 where weight percent (wt. %) metal content is relative to the concentration in the feed solution.

TABLE 2
Consecutive transition metal capture and release from copolymer

| | First Iteration | Second Iteration |
|---|---|---|
| | Transition Metal | Transition Metal |
| | Content in Aqueous | Content in Aqueous |
| Transition Metal | Extraction (wt. %) | Extraction (wt. %) |
| Co²⁺ | 53.1 | 71.9 |
| Mn²⁺ | 36.1 | 77.3 |
| Ni²⁺ | 81.5 | 73.1 |

The reusability of the copolymer for recovering different transition metal cations consecutively was characterized. The copolymer having a 10:1 equivalent min was used to capture Ni²⁺, Mn²⁺, and then Co²⁺. The copolymer was dissolved in ethyl acetate, and then irradiated at 365 nm for 5 minutes, followed by the addition of the transition metal solution. The polymer was precipitated with diethyl ether and then centrifuge to isolate the polymer. The transition metal was then extracted from the polymer by illumination with light at 620 nm and polar extraction. This process of capture and release of the transition metal cations was repeated for each of the transition metals. IC was used to characterize the aqueous extraction phase. Results indicated Ni recovery of 73.1%, Mn recovery of 73.4%, and Co recovery of 59.4% for each of the respective aqueous extraction phases. Furthermore, the results indicated the lack of cross-contamination between the transition metal recovery steps, with no Ni present in the second or third extractions, and no Mn present in the third extraction.

### Example 4: Further Transition Metal Capture

TABLE 3
Consecutive transition metal capture and release from copolymer.

| | First | Second | Third |
|---|---|---|---|
| | Iteration | Iteration | Iteration |
| | Transition | Transition | Transition |
| | Metal | Metal | Metal |
| | Content | Content | Content |
| | in Aqueous | in Aqueous | in Aqueous |
| | Extraction | Extraction | Extraction |
| Transition Metal | (wt. %) | (wt. %) | (wt. %) |
| Co²⁺ | 59.5 | 52.9 | 89.1 |
| Mn²⁺ | 82.4 | 82 | 74.9 |
| Ni²⁺ | 84.1 | 75.4 | 75.6 |

Table 3 shows separate systems and recover of the separate ions form solution. The first plot shows one batch of polymer undergoing three cycles of Ni capture and release. The second and third plots show the corresponding results for Mn and Co, respectively. The Data is obtained through Ion Chromatography (IC) measurement of the aqueous layer (bottom left figure in page 2).

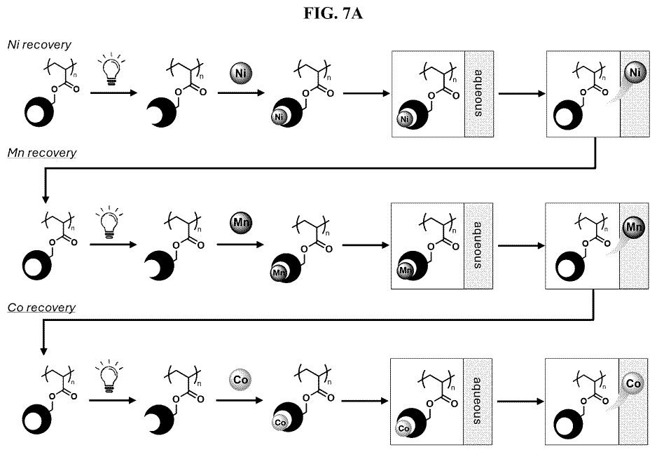

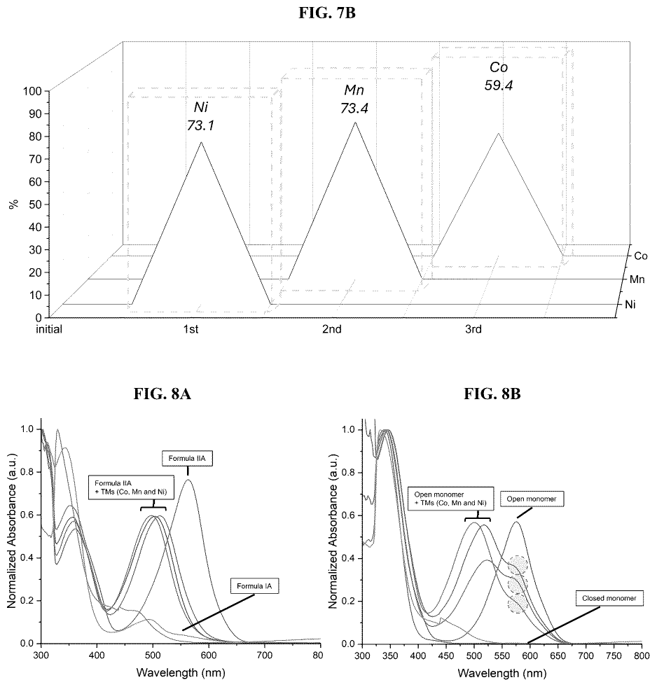

As shown in FIGS. 7A and 7B, the Ni, Mn, and Co can be separated sequentially with little to no overlap in recovery samples. One batch of polymer (for Ni recovery) is activated with UV light, followed by addition of transition metal ions. After isolation of the polymer and metal ion compound, it is treated with organic solvent and water to release metal ions into aqueous phase in the presence of ambient light, where polymer converts back to close form again. The amount of transition metal released in each cycle was measured by IC, and the results are shown in the right-hand plot.

### Example 5: Additional Transition Metal Capture

The polymer of example 2 may also be used to capture other metals, including Cu. In recovery tests, Ni, Mn, Co, and Cu were recovered, with the polymer showing a competitive relationship between Co and Cu recovery. This is an experiment where the polymer is treated with a solution including various metal ions. The single Cu recovery reached 72.8%. Table 4 presents an experiment in which the polymer was treated with four transition metals simultaneously. T his serves as a preliminary selectivity test among various metal ions.

TABLE 4
Selective transition metal capture and release from copolymer.

| Transition Metal | Recovery (wt. %) |
|---|---|
| Co²⁺ | 5 |
| Mn²⁺ | 67 |
| Ni²⁺ | 54 |
| Cu²⁺ | 35 |

### Example 6: Spectroscopic Shift

FIGS. 8A and 8B illustrate the improvement in binding of a metal to the active center in the polymers (8A) as compared to the monomer counterpart (8B). The spectra show the absorption of different stages during the process and the shift in absorption indicates the occurrence of transition metal (TM) binding. In FIG. 8A, the TM-bound open form predominates in the presence of TM ions (see the “Formula IIA+TM) and no remaining “open” form (Formula IIA) of the chelator is observed. Comparatively, in FIG. 8B, even in the presence of TMs, absorption attributed to the unbound “open” form remains plainly evident (labelled as “open monomer”). Thus, it may be suggested that the monomer has a lower binding efficiency for transition metals than the polymer.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A polymer comprising a spiropyran functional group that is photoswitchable between a spiropyran form and a merocyanine form, a donor-acceptor Stenhouse adduct (DASA) functional group that is photoswitchable between a cyclopentenone and a hexatrienol, or a combination of any two or more thereof.

2. The polymer of claim 1, wherein the spiropyran functional group and the DASA functional group is photoswitchable at a wavelength of about 300 nm to about 900 nm.

3. The polymer of claim 1, wherein the spiropyran functional group is photoswitchable from the spiropyran form to the merocyanine form at a wavelength of about 300 nm to about 450 nm.

4. The polymer of claim 1, wherein the spiropyran functional group is photoswitchable from the merocyanine form to the spiropyran form at a wavelength of about 550 nm to about 700 nm.

5. The polymer of claim 1, wherein the polymer comprises a backbone comprising a polyethylene, a polysiloxane, a polypropylene, a polyamide, or a combination of any two or more thereof.

6. The polymer of claim 1 having a structure as represented by any one or more of Formulae I, II, III, or IV: 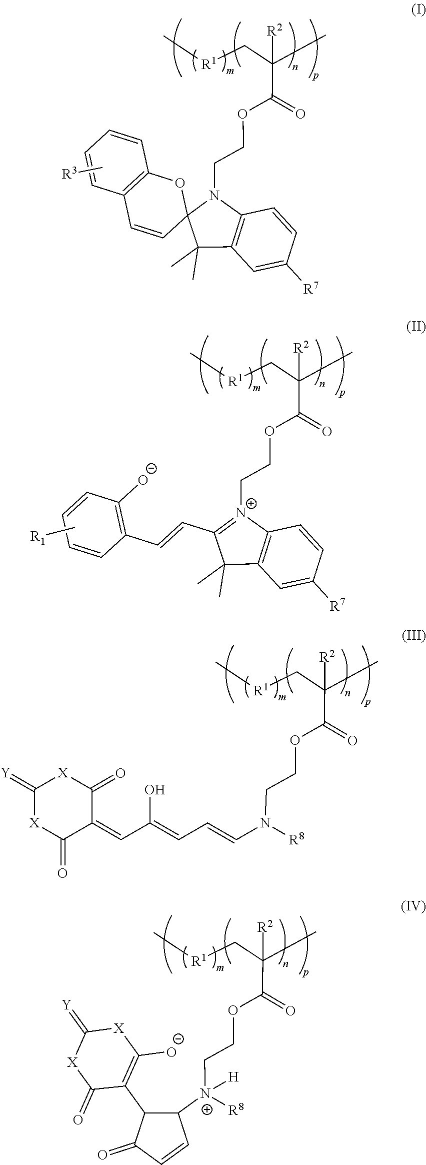
wherein:
R¹ is a group of formula: 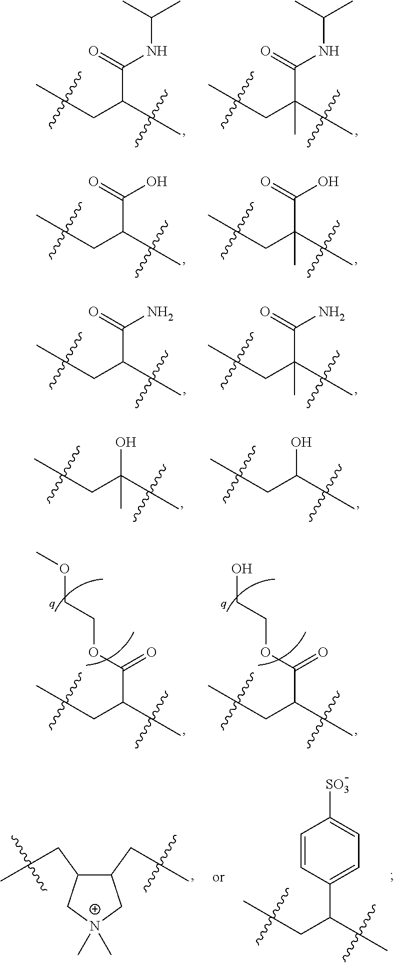
R² is H or C₁-C₆ alkyl;
R³ is H, alkyl, substituted alkyl, alkenyl, alkynyl, halogen, alkylcarboxylic acid, NO₂, OCH₃, N(CH₃)₂, CN, morpholine, alkylmorpholinyl, OH, NH₂, substituted bicyclic alkyl, or forms part of an aryl;
R⁷ is H, alkyl, substituted alkyl, alkenyl, alkynyl, halogen, NO₂, OCH₃, N(CH₃)₂, CN, morpholine, OH, NH₂, or substituted bicyclic alkyl;
R⁸ is H or alkyl;
X is N or O;
Y is O;
n is 1 to 1000;
m is 1 to 1000;
p is 1 to 1000; and
q is 1 to 5.

7. The polymer of claim 1 represented by Formula IA or Formula IIA: 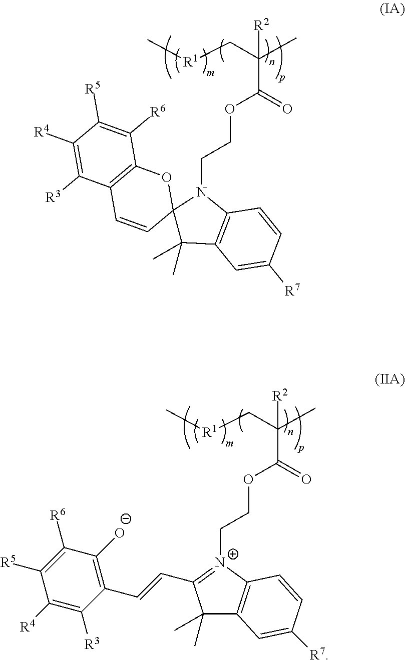
wherein:
R¹ is a group of formula: 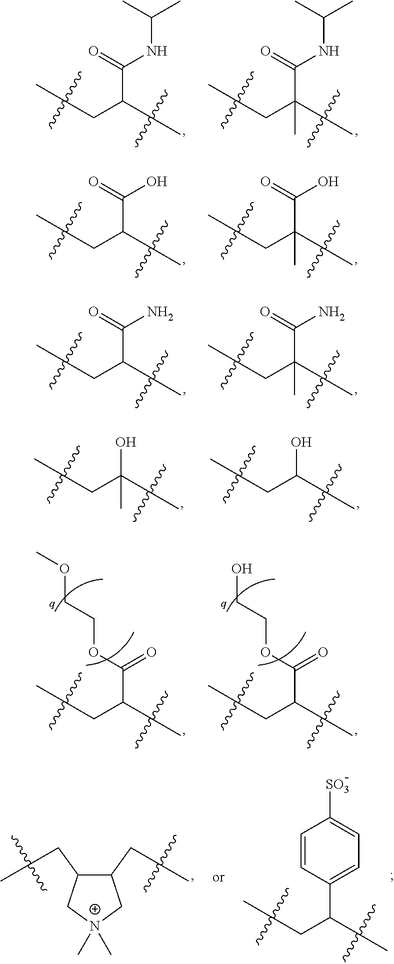
R² is H or alkyl;
R³ is H, alkyl, substituted alkyl, alkenyl, alkynyl, halogen, NO₂, OCH₃, N(R¹¹)₂, CN, morpholine, OH, NH₂, substituted bicyclic alkyl, or R³ forms an aryl with R⁴;
R⁴ is H, alkyl, substituted alkyl, alkenyl, alkynyl, halogen, NO₂, OCH₃, N(R¹¹)₂, CN, morpholine, OH, NH₂, or substituted bicyclic alkyl, or R⁴ forms an aryl with R³ or R⁵;
R⁵ is H, alkyl, substituted alkyl, alkenyl, alkynyl, halogen, NO₂, OCH₃, N(R¹¹)₂, CN, morpholine, OH, NH₂, or substituted bicyclic alkyl, or R⁵ forms an aryl with R⁴ or R⁶;
R⁶ is H, alkyl, substituted alkyl, alkenyl, alkynyl, halogen, NO₂, OCH₃, N(R¹¹)₂, CN, morpholine, OH, NH₂, or substituted bicyclic alkyl, 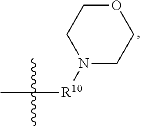
or R⁶ forms an aryl with R⁵;
R⁷ is H, alkyl, substituted alkyl, alkenyl, alkynyl, halogen, NO₂, OCH₃, N(R¹¹)₂, CN, morpholine, OH, NH₂, or substituted bicyclic alkyl;
R¹⁰ is C₁-C₆ alkylenyl;
R¹¹ is individually C₁-C₆ alkyl;
n is 1 to 1000;
m is 1 to 1000;
p is 1 to 1000; and
q is 1 to 5.

8. The polymer of claim 6, wherein a ratio of min is about 4:1 to about 20:1.

9. The polymer of claim 6, wherein the polymer has an average molecular weight of about 4400 Da to about 90000 Da.

10. The polymer of claim 1, wherein the polymer is formula: 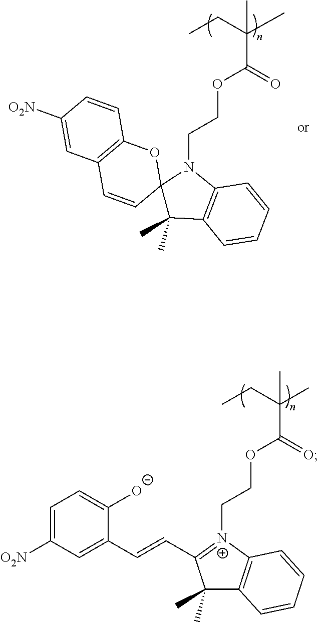
wherein n is 1 to 10000.

11. A method of recovering a transition metal cation from a solution comprising the transition metal cation, the method comprising:
illuminating a polymer with a functional group with light having a wavelength of about 300 nm to about 450 nm to photoswitch the functional group from a spiropyran functional group to a merocyanine functional group or photoswitch the functional group from a hexatrienol functional group to a cyclopentenone functional group; and
contacting the solution with the polymer comprising the merocyanine functional group or the cyclopentenone functional group, the merocyanine functional group configured to form a complex with the transition metal cation and the cyclopentenone functional group configured to form a complex with the transition metal cation.

12. The method of claim 11 further comprising decomplexing the transition metal cation from the polymer by illuminating the polymer with light having a wavelength of about 550 nm to about 700 nm to photoswitch the merocyanine functional group to the spiropyran functional group or the cyclopentenone functional group to the hexatrienol functional group to dissociate the transition metal cation from the functional group.

13. The method of claim 11, wherein the polymer is represented by Formulae I, II, III, IV: 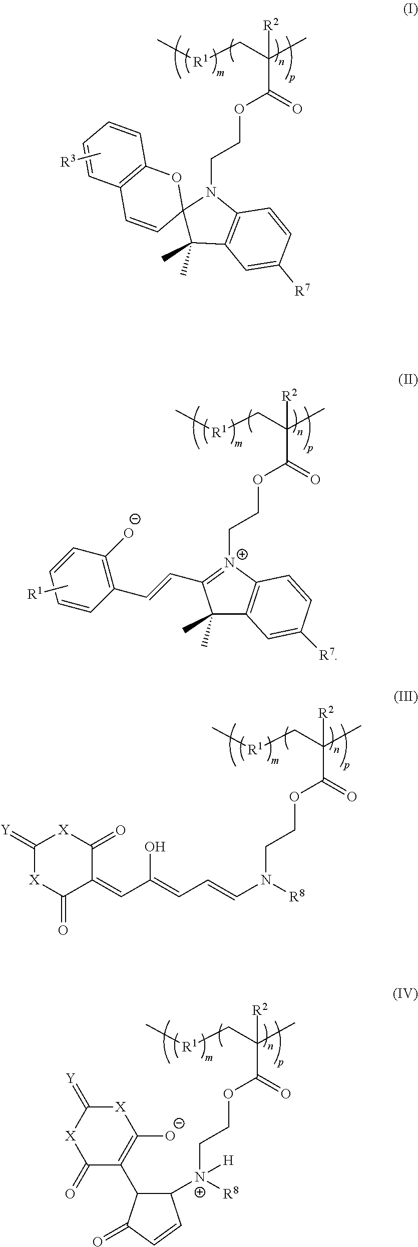
wherein:
R¹ is a group of formula: 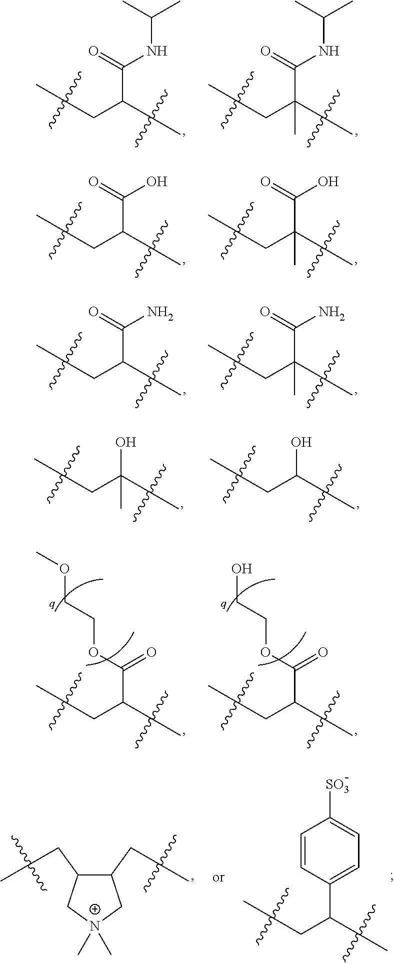
R² is methyl or H;
R³ is alkyl, substituted alkyl, alkenyl, alkynyl, halogen, NO₂, OCH₃, N(CH₃)₂, CN, morpholine, OH, NH₂, substituted bicyclic alkyl, or forms part of an aryl;
R⁷ is alkyl, substituted alkyl, alkenyl, alkynyl, halogen, NO₂, OCH₃, N(CH₃)₂, CN, morpholine, OH, NH₂, or substituted bicyclic alkyl;
R⁸ is alkyl or hydrogen;
X is N or O;
Y is O;
n is 1 to 1000;
m is 1 to 1000;
p is 1 to 1000; and
q is 1 to 5.

14. The method of claim 13, wherein a ratio of min is about 4:1 to about 20:1.

15. The method of claim 13, wherein the polymer has an average molecular weight of about 4400 Da to about 90000 Da.

16. The method of claim 11, wherein the polymer is represented by: 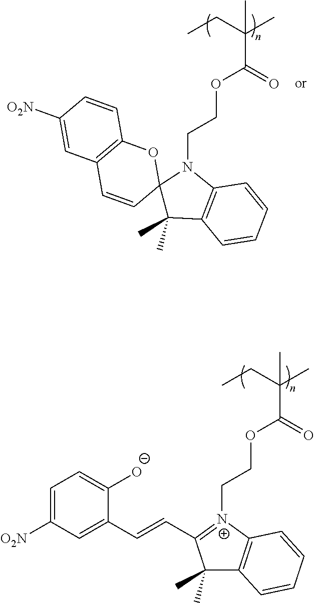
wherein n is 1 to 10000.

17. The method of claim 11, wherein the transition metal cation comprises an ion of manganese, nickel, copper, or cobalt.

18. A polymer represented by Formula IA or Formula IIA: 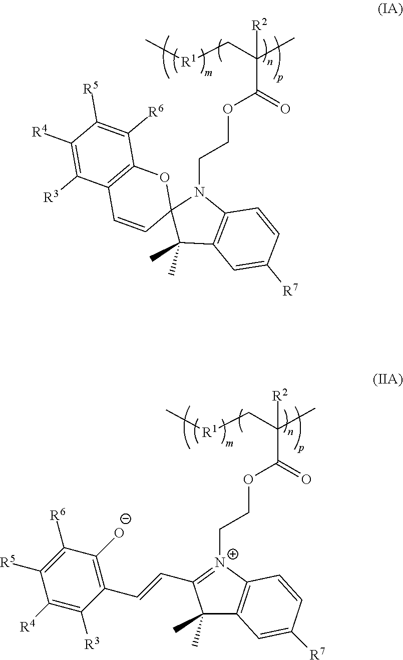
wherein:
R¹ is a group of formula: 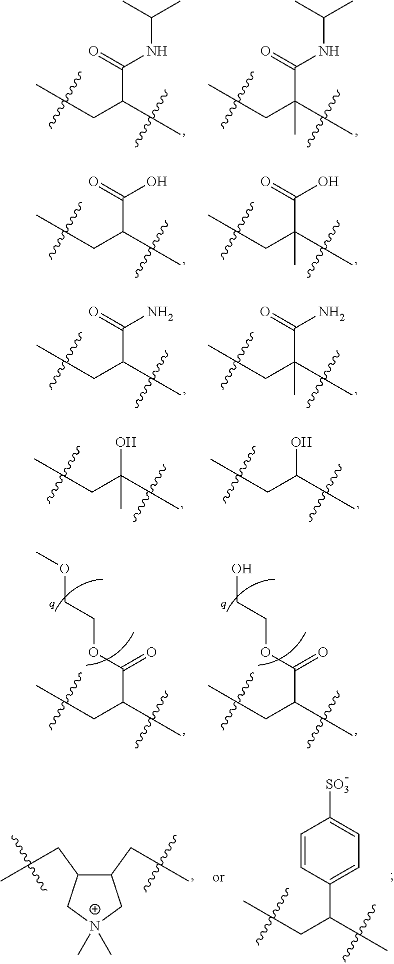
R² is H or alkyl;
R³ is H, alkyl, substituted alkyl, alkenyl, alkynyl, halogen, NO₂, OCH₃, N(R¹¹)₂, CN, morpholine, OH, NH₂, substituted bicyclic alkyl, or R³ forms an aryl with R⁴;
R⁴ is H, alkyl, substituted alkyl, alkenyl, alkynyl, halogen, NO₂, OCH₃, N(R¹¹)₂, CN, morpholine, OH, NH₂, or substituted bicyclic alkyl, or R⁴ forms an aryl with R³ or R⁵;
R⁵ is H, alkyl, substituted alkyl, alkenyl, alkynyl, halogen, NO₂, OCH₃, N(R¹¹)₂, CN, morpholine, OH, NH₂, or substituted bicyclic alkyl, or R⁵ forms an aryl with R⁴ or R⁶;
R⁶ is H, alkyl, substituted alkyl, alkenyl, alkynyl, halogen, NO₂, OCH₃, N(R¹¹)₂, CN, morpholine, OH, NH₂, or Smailes bstituted bicyclic alkyl, 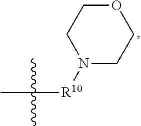
or R⁶ forms an aryl with R⁵;
R⁷ is H, alkyl, substituted alkyl, alkenyl, alkynyl, halogen, NO₂, OCH₃, N(R¹¹)₂, CN, morpholine, OH, NH₂, or substituted bicyclic alkyl;
R¹⁰ is C₁-C₆ alkylenyl;
R¹¹ is individually C₁-C₆ alkyl;
n is 1 to 1000;
m is 1 to 1000;
p is 1 to 1000; and
q is 1 to 5.

19. The polymer of claim 18, wherein a ratio of min is about 4:1 to about 20:1.

20. The polymer of claim 18 having an average molecular weight of about 4400 Da to about 90000 Da.
